(19) United States
(12) Patent Application Publication
(10) Pub. No.: US 2009/0186143 A1
(43) Pub. Date: Jul. 23, 2009

(54) METHOD OF ACCELERATING LIQUOR AGING PROCESS

(76) Inventor: Chuan-Tao Ko, Fongyuan City (TW)

Correspondence Address: PAI PATENT & TRADEMARK LAW FIRM, 1001 FOURTH AVENUE, SUITE 3200, SEATTLE, WA, 98154, US

(21) Appl. No.: 12/018,143

(22) Filed: Jan. 22, 2008

(51) Int. Cl. C12H 1/22; C12H 1/00

(52) U.S. Cl. 426/592

(57) ABSTRACT

A method of accelerating liquor aging process includes acts of preparing a liquor having by-products, preparing a nano-gold surface by sputtering gold nanoparticles onto a substrate, barreling the liquor and the nano-gold surface into a barrel, circulating the liquor and removing a product of artificially aged liquor. The liquor is circulated by a pump for increased rate of diffusion and incidences of collision between the by-products and nano-gold surface. The gold nanoparticles serve as a catalyst to promote oxidation of by products including formaldehyde, acetaldehyde and fusel alcohols in the liquor into organic acids and esterification of organic acids to accelerate the liquor aging process of the. After the product is removed, the nano-gold surface can be recycled. The gold nano-particles do not aggregate or precipitate in the liquor, therefor, perform more predictably so reduce manufacturing costs and improve consistency of manufacture.

### BACKGROUND OF THE INVENTION

1. Field of Invention

The present invention relates to liquor, and more particularly to a method of accelerating liquor aging process of by circulating with a non-destructive nano-gold catalyst.

2. Description of the Related Art

Liquors are a range of alcoholic drinks produced by distillation including but not limited to whiskey, vodka, brandy and the like.

During production of liquors, an aging process of the liquor is required for oxidation of formaldehyde, acetaldehyde and fusel alcohols in the liquor into organic acids and esterification of organic acids to improve taste and smoothness of the liquor. Traditionally, the aging process was to leave the liquor in a barrel for at least 5 years. However, raising storage costs led to speeding up the aging process.

Conventional aging processes use gold to catalyze and speed up oxidation and esterification reactions and accelerate the aging process of liquors.

Most conventional techniques are performed by directly adding inert gold foil, gold powder or nano-gold powder into the liquor before storing. However, gold foil, gold powder or nano-gold powder have high manufacturing costs and may aggregate or precipitate in the liquor thereby reducing active surface area and raising storage length or quantity of gold required. Accordingly, quality and appearance of liquors are unpredictably affected resulting in inconsistency of batches and variable production times and costs.

To overcome the shortcomings, the present invention provides a method of accelerating liquor aging process to mitigate or obviate the aforementioned problems.

### SUMMARY OF THE INVENTION

The primary objective of the present invention is to provide a method of accelerating liquor aging process by circulating with a non-destructive nano-gold catalyst to lower manufacturing costs and prevent aggregation or precipitation, thereby raising consistency.

A method of accelerating liquor aging process in accordance with the present invention comprises acts of: preparing a liquor, preparing a nano-gold surface, barreling, circulating and removing a product.

In the act of preparing a liquor, the liquor is produced using conventional techniques, the liquor consisting of by-products requiring oxidation and esterification.

In the act of preparing a nano-gold surface, gold nanoparticles are prepared and coated onto a substrate by sputtering to obtain the nano-gold surface. In the act of barreling, the liquor and nano-gold surface are put together in a barrel and the barrel is sealed.

In the act of circulating, the liquor is forced to circulate to increase a rate of diffusion, thereby raising a rate of collision between the by-products and the gold nanoparticles of the nano-gold surface. The gold nanoparticles serve as a catalyst to facilitate oxidation of the by-products including formaldehyde, acetaldehyde and fusel alcohol in the liquor into organic acids and esterification of organic acids to accelerate the liquor aging process.

In the act of removing a product, a product of artificially aged liquor is obtained and the nano-gold surface may be recycled for further use since the gold nano-particles do not aggregate or precipitate in the liquor thereby also raising consistency of manufacture while reducing cost of manufacture.

Other objectives, advantages and novel features of the invention will become more apparent from the following detailed description when taken in conjunction with the accompanying drawings.

### BRIEF DESCRIPTION OF THE DRAWINGS

FIG. 1 is a block flow diagram of a method of accelerating an aging process of liquors in accordance with the present invention; and

FIG. 2 is schematic diagram of a barrel connected to a pump with a circulation pipe in accordance with the present invention.

### DETAILED DESCRIPTION OF THE INVENTION

As defined herein, liquors are a range of alcoholic drinks produced by distillation including but not limited to whiskey, vodka, brandy and the like.

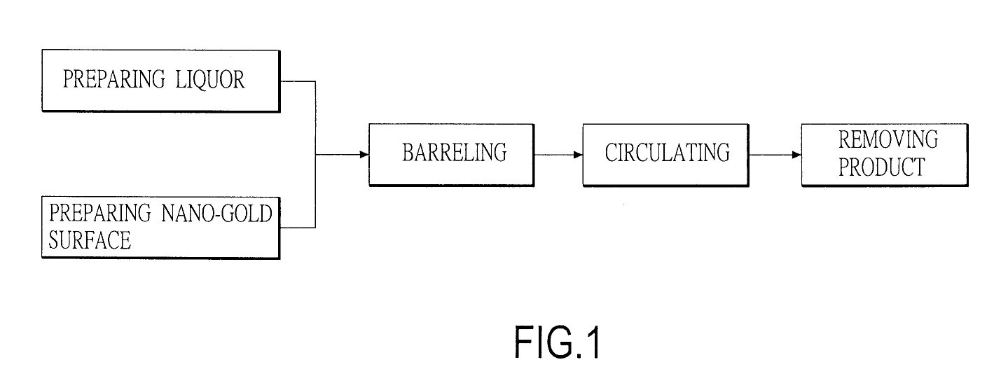

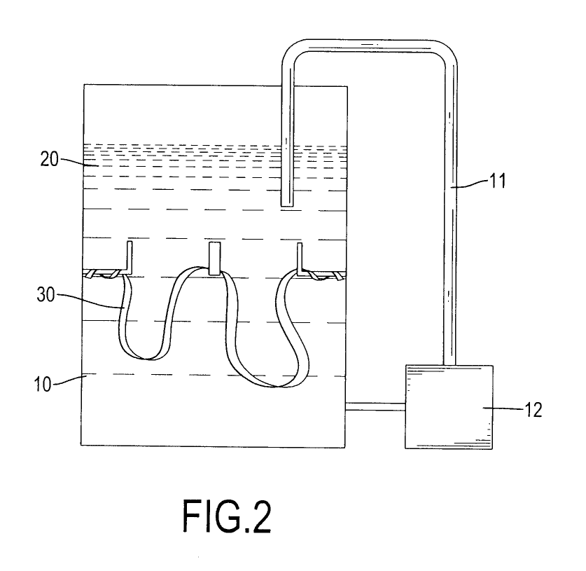

With reference to FIGS. 1 and 2, a method of accelerating liquor aging process in accordance with the present invention comprises acts of preparing a liquor (20), preparing a nano-gold surface, barreling, circulating and removing a product.

In the act of preparing the liquor (20), the liquor (20) is produced using conventional techniques and comprises by-products requiring esterification and oxidation and may be a sorghum liquor or vinous liquor. The by-products may be formaldehyde, acetaldehyde, fusel alcohols, organic acids and the like.

In the act of preparing a nano-gold surface, gold nanoparticles are prepared and coated onto a substrate by sputtering to obtain the nano-gold surface (30) with gold nanoparticles on a surface of the substrate. The substrate may be a cloth, an inner surface of a reaction vessel, a wire wool for increased surface area or the like. The cloth may be non-woven cloth. The wire wool may be plastic or metal. An amount of the gold nanoparticles can be easily adjusted for various liquors.

In the act of barreling, the liquor (20) and the nano-gold surface (30) are put together into a barrel (10) and then the barrel (10) is sealed for a length of time.

In the act of circulating, the liquor (20) is forced to circulate to increase a rate of diffusion, thereby raising a rate of interception between the by-products of the liquor (20) and the gold nanoparticles of the nano-gold surface (30). Preferably, the barrel (10) is connected to a pump (12) with a circulation pipe (11) and the liquor (20) is pumped through the pipe (11) by the pump (12). Circulation is more reliable than agitation or ultrasonic vibration creating more consistent results.

The gold nanoparticles serve as a catalyst to promote oxidation of bitter-tasting and unpleasant formaldehyde, acetaldehyde and fusel alcohol in the liquor (20) into organic acids and esterification of organic acids to improve taste and effects of the liquor (20). Therefore, an aging period of the liquor (20) is substantially shortened and an effect of accelerating the aging process of the liquor (20) is achieved. When circulated the length of time is reduced in comparison with a non-circulated method. Experimental results of the inventor show that one-month of circulating under pre-described conditions is equivalent to non-catalyzed aging for ten years.

In the act of removing a product, once the length of time is complete, the product of artificially aged liquor (20) is removed and may be bottled.

After the product is obtained, the nano-gold surface can be retrieved and reused, therefore reducing manufacturing costs of the product while improving consistency of the product. When the product is put into bottles, the gold nano-particles are not present in the liquor, improving quality and appearance of the product.

What is claimed is:

1. A method of accelerating liquor aging process comprising acts of:
preparing a liquor;
preparing a nano-gold surface, comprising acts of
preparing gold nanoparticles; and
coating a substrate by sputtering with gold nanoparticles to obtain the nano-gold surface;
barreling, comprising acts of
putting the liquor and the nano-gold surface together into a barrel; and
sealing the barrel;
circulating, comprising forcing the liquor to circulate to increase diffusion to promote oxidation of formaldehyde, acetaldehyde and fusel alcohols in the liquor into organic acids and esterification of organic acids thereby accelerating the liquor aging process; and
removing a product of artificially aged liquor after the circulating.

2. The method of accelerating liquor aging process as claimed in claim 1, wherein the substrate is a cloth.

3. The method of accelerating liquor aging process as claimed in claim 1, wherein the substrate is a non-woven cloth.

4. The method of accelerating liquor aging process as claimed in claim 1, wherein the barrel is connected to a pump with a circulation pipe and the liquor is pumped through the pipe by the pump.

5. The method of accelerating liquor aging process as claimed in claim 2, wherein the barrel is connected to a pump with a circulation pipe and the liquor is pumped through the pipe by the pump.

6. The method of accelerating liquor aging process as claimed in claim 3, wherein the barrel is connected to a pump with a circulation pipe and the liquor is pumped through the pipe by the pump.
